(19) United States
(12) Patent Application Publication
(10) Pub. No.: US 2026/0090943 A1
(43) Pub. Date: Apr. 2, 2026

(54) MASSAGE APPLIANCE

(71) Applicant: Shenzhen Xindeli Technology Industrial Co., Ltd, Shenzhen (CN)

(72) Inventor: Honghui LIN, Shenzhen (CN)

(73) Assignee: Shenzhen Xindeli Technology Industrial Co., Ltd, Shenzhen (CN)

(21) Appl. No.: 19/344,420

(22) Filed: Sep. 29, 2025

(30) Foreign Application Priority Data
Sep. 29, 2024 (CN) 2024113670221

(51) Int. Cl. A61H 7/00; A61H 9/00; A61H 23/00; A61H 23/02

(52) U.S. Cl. CPC A61H 7/007; A61H 7/005; A61H 9/005; A61H 23/006; A61H 23/0254; A61H 2201/0153; A61H 2201/0169; A61H 2201/1238; A61H 2201/1676; A61H 2201/5035

(57) ABSTRACT

The invention discloses a massage appliance, including a housing with rubber sleeve, a control assembly, and a first massage mechanism. The first massage mechanism includes a chamber with an opening, and the chamber is provided with an opening. The control assembly includes an air pump. An air inlet of the air pump is in communication with the chamber, by controlling the air pump, the chamber pressure that matches the massage area is changed, altering the chamber pressure and size. When in use, use an air pump to change the chamber pressure, causing the chamber opening to contract and compress the massage area, creating a massage effect.

### CROSS-REFERENCE TO RELATED APPLICATIONS

The application claims priority to Chinese patent application No. 2024113670221, filed on Sep. 29, 2024, the entire contents of which are incorporated herein by reference.

### TECHNICAL FIELD

The present invention relates to the technical field of massage, and in particular to a massage appliance.

### BACKGROUND

Massage appliances can relieve pressure, relax the body and mind, and alleviate fatigue for people engaged in intense work, so they are increasingly used. Existing massage appliances perform massage through methods such as tapping. Although such massage can achieve a certain purpose, the tapping action generates relatively loud noise, and the tapping force cannot be adjusted continuously, resulting in a poor massage experience.

### SUMMARY

The primary technical problem addressed by the present invention is to provide a massage appliance, which can perform gentle kneading massage on the massage site, thereby improving a use experience.

In order to solve the above problems, the present invention provides a massage appliance, including a housing, a control assembly, and a first massage mechanism, where the housing is sleeved with a rubber sleeve, where the first massage mechanism includes a chamber disposed within the rubber sleeve, and the chamber is provided with an opening; the control assembly includes a control circuit board and an air pump connected to the control circuit board, an air inlet of the air pump is in communication with the chamber, and under control of the control circuit board, the air pump causes a change in air pressure of the chamber cooperating with a massage site, thereby altering the air pressure and a size of the chamber.

Preferably, an end face of the opening is arc-shaped, and the opening is provided with two slots on the same straight line.

Preferably, the chamber increases from the inside to the outside in a length direction, and a thickness of a side wall of the chamber gradually increases from the inside to the outside.

Preferably, the chamber is provided with a through hole, the through hole is located at a bottom of the chamber, and the through hole communicates the air inlet of the pump with the chamber through a control air valve.

Preferably, the rubber sleeve further includes a shifting tongue disposed in the chamber and moved under control of the control assembly.

Preferably, the first massage mechanism further includes a first vibration motor and a fixing seat for fixing the first vibration motor, the fixing seat is provided with a mounting cavity and a mounting slot communicating with the mounting cavity, a circuit connecting the first vibration motor and the control circuit board passes through the mounting slot, and under the control of the control circuit board, the first vibration motor drives the shifting tongue to perform vibration massage.

Preferably, the first massage mechanism further includes a reduction motor, an output shaft of the reduction motor is connected to the fixing seat, and through the control of the control circuit board, the reduction motor drives an operating first vibration motor to make the shifting tongue perform swing massage and vibration massage, or the reduction motor causes the shifting tongue to perform swing massage through the first vibration motor.

Preferably, the output shaft includes an output end connected to the fixing seat and an input end connected to the reduction motor, an included angle is formed between the input end and the output end, and the included angle is 165-173 degrees.

Preferably, the shifting tongue is an elastic or flexible shifting piece.

Preferably, the massage appliance further includes a second massage mechanism, the second massage mechanism includes a massage body and a second vibration motor disposed on the massage body, and under the control of the control circuit board, the second vibration motor causes the massage body to generate vibration massage.

Preferably, the housing is provided with a fixing portion for mounting the massage body, the fixing portion includes a protrusion along a length direction, and fixing slots are annularly distributed on a surface of the protrusion.

Preferably, a control valve controlled by the control circuit board is disposed between the air pump and the chamber.

Preferably, an end of the massage body is provided with a massage ball, a diameter of the massage body gradually decreases from the housing to the massage ball, and a diameter of the massage ball is larger than a minimum diameter of the massage body and smaller than a maximum diameter of the massage body.

During use, the opening of the chamber is brought into contact with the massage site. The air pressure of the chamber is altered by controlling the air pump. When the air pressure of the chamber decreases, the opening of the chamber contracts to form a squeeze on the massage site. When the air pressure of the chamber is changed periodically, continuous kneading massage can be achieved. Since the air pressure of the chamber formed by the elastic rubber sleeve is changed, the massage is gentler, and massage intensity can be adjusted continuously, thereby improving a use experience of a user. In addition, when the massage appliance is provided with the shifting piece, a motor inside the shifting piece achieves kneading massage. At the same time, the shifting piece can perform vibration massage and/or swing massage, allowing a single massage appliance to provide multiple types of massage simultaneously.

### BRIEF DESCRIPTION OF DRAWINGS

In order to clarify the technical solutions in the embodiments of the present invention or the prior art, a brief description of the drawings required in the description of the embodiments or the prior art will be given below. Obviously, the drawings in the description only show some embodiments of the present invention and should therefore not be considered as limiting the scope. For those of ordinary skill in the art, other relevant drawings can also be obtained from these drawings without exerting creative efforts.

FIG. 1 is a schematic structural diagram of an embodiment of a massage appliance of the present invention.

FIG. 2 is a schematic cross-sectional structural diagram of FIG. 1 along an A-A direction.

FIG. 3 is a schematic three-dimensional structural diagram from a first perspective of an embodiment of a massage appliance of the present invention.

FIG. 4 is a schematic three-dimensional structural diagram from a second perspective of an embodiment of a massage appliance of the present invention.

FIG. 5 is a schematic structural diagram from another perspective of an embodiment of a massage appliance of the present invention.

FIG. 6 is a schematic exploded structural diagram from a first perspective of an embodiment of a massage appliance of the present invention.

FIG. 7 is a schematic exploded structural diagram from a second perspective of an embodiment of a massage appliance of the present invention.

The objective realization, functional features, and advantages of the present invention will be further described in conjunction with the embodiments and with reference to the drawings.

### DETAILED DESCRIPTION OF THE EMBODIMENTS

The following provides a further detailed description of the claims of the present invention in conjunction with specific embodiments and the drawings. Obviously, the described embodiments are only a part of the embodiments of the present invention, rather than all the embodiments. Based on the embodiments in the present invention, all other embodiments obtained by those of ordinary skill in the art without making creative efforts shall also fall within the scope of protection of the present invention.

It should be understood that, in the description of the embodiments of the present invention, all terms of directional indication, such as “upper,” “lower,” “left,” “right,” “front,” “rear,” etc., indicate orientations or positional relationships based on the orientations or positional relationships shown in the drawings, or the orientations or positional relationships that the product of the present invention is typically placed in during use. These terms are only for the convenience of simplifying the description of the present invention, and do not explicitly or implicitly indicate that the referenced device, element, or component must have a specific orientation or be constructed in a specific orientation, and shall not be construed as limiting the present invention. They are only used to explain the relative positional relationships, movement conditions, etc., between the components as shown in the drawings. When the specific posture changes, the directional indications may also change accordingly.

In addition, in the present invention, ordinal numbers such as “first,” “second,” etc., are used only for distinguishing purposes and should not be construed as indicating or implying their relative importance or implicitly indicating the quantity of the technical features they refer to.

The preferred embodiments of the present invention are described below in conjunction with the drawings. It should be understood that the preferred embodiments described herein are only used to illustrate and explain the present invention, and are not intended to limit the present invention.

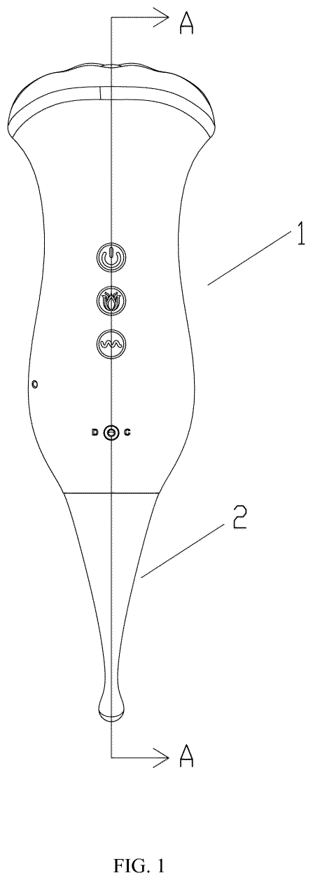

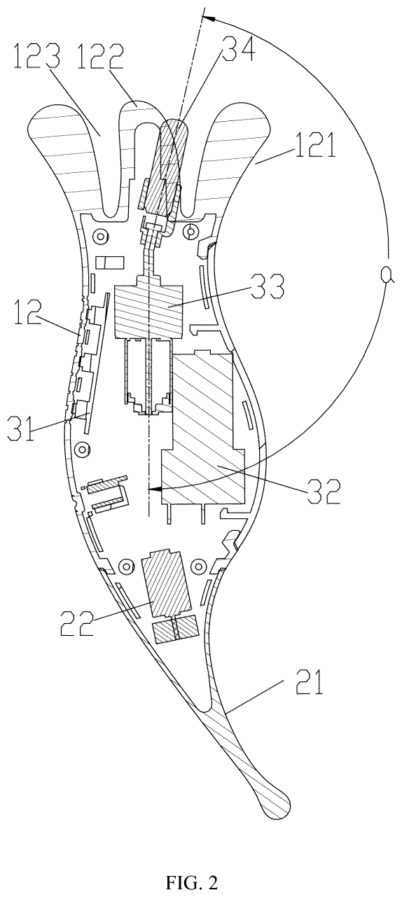

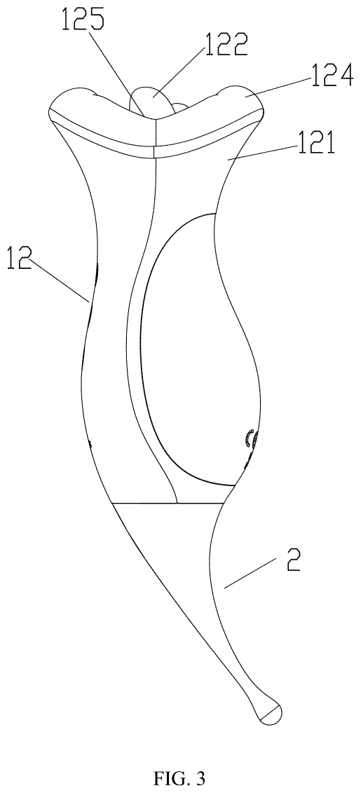

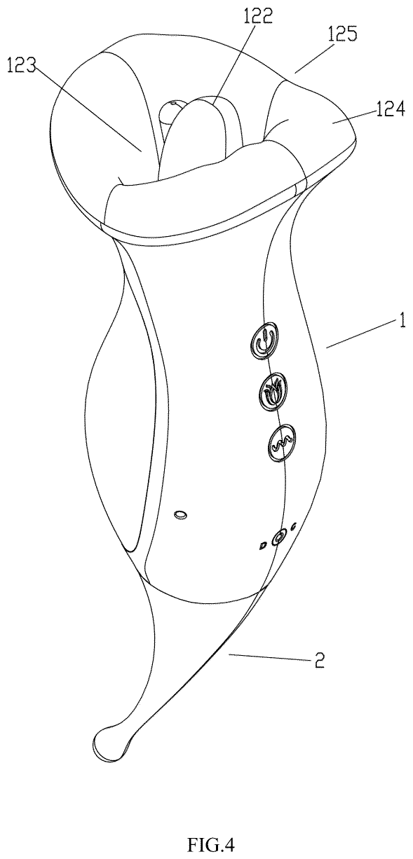

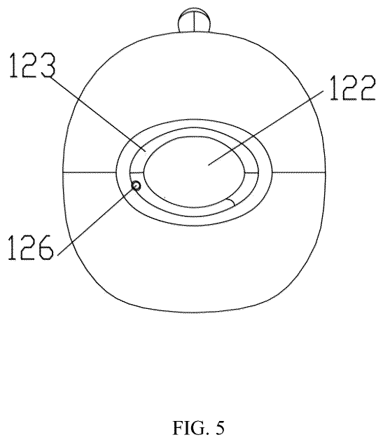

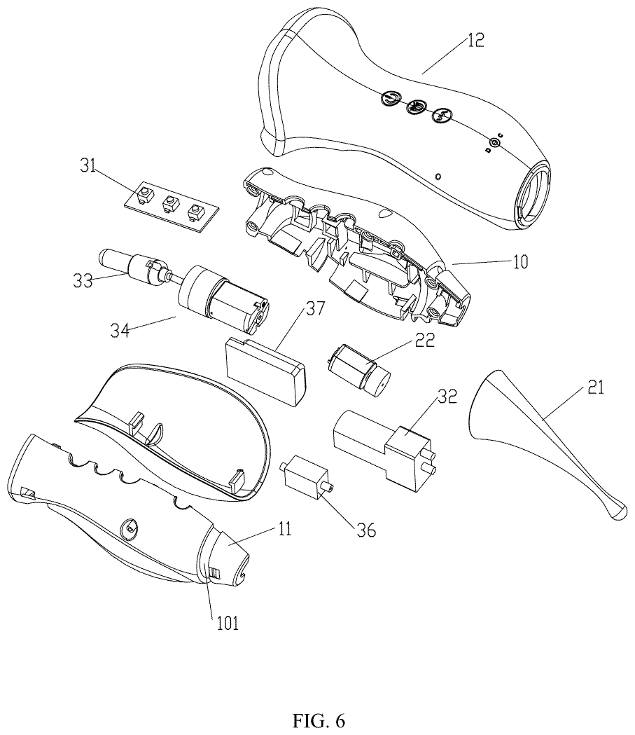

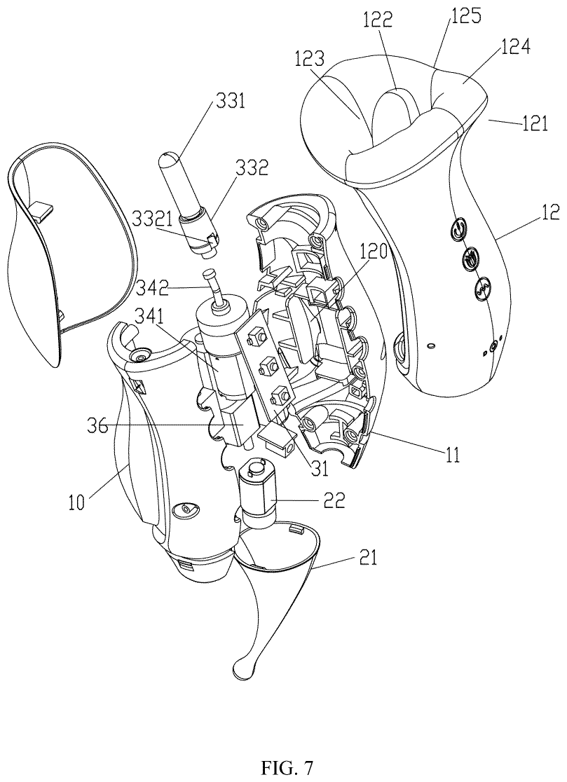

As shown in FIGS. 1-7, the present invention provides an embodiment of a massage appliance.

The massage appliance includes a housing 1, a control assembly, and a first massage mechanism. The housing 1 is sleeved with a rubber sleeve 12. The first massage mechanism includes a chamber 123 formed on the rubber sleeve 12, i.e., the chamber 123 is disposed on the rubber sleeve 12, and the chamber 123 is provided with an opening 124 and a through hole 126. The control assembly includes a control circuit board 31 and an air pump 32 connected to the control circuit board 31. An air inlet of the air pump 32 is in communication with the chamber 123 through the through hole 126. Under the control of the control circuit board 31, the air pump causes a change in air pressure of the chamber cooperating with a massage site, thereby altering the air pressure and a size of the chamber.

Specifically, the housing 1 includes an upper shell 10 and a lower shell 11 cooperating with the upper shell 10 to form a space for mounting a control assembly 3. A surface of the housing 1 is covered with the rubber sleeve 12, and the rubber sleeve 12 typically has an elastic or flexible material, such as silicone. The rubber sleeve 12 is provided with the chamber 123, and a side wall of the chamber 123 and the rubber sleeve 12 adopt an integrated structure. A massage end of the chamber 123 is provided with the opening 124, and an end face of the opening 124 is arc-shaped, which can not only increase a contact area between the massage end and the massage site, but also enhance air tightness, thereby improving comfort and a massage effect during kneading massage. An edge of the opening 124 may be provided with two slots 125, and the two slots 125 are on the same line. The slots 125 make the end face of the opening 124 have a structure similar to a V-shape or a U-shape, which can make it easier to change the size of the chamber 123 and control a deformation direction of the opening 124 during massage. At the same time, this structure can better contact a non-planar massage site and enable the chamber to form relatively good air tightness during massage. The control circuit board 31 is provided with a control circuit and control buttons, and it can be powered by a battery 37 or connected to an external power source via a power interface.

During operation, the opening 124 of the chamber 123 cooperates with the massage site, i.e., the chamber is covered over the massage site through the opening 124. Under the control of the control circuit board 31, the air pump 32 causes a change in the air pressure inside the chamber 123 cooperating with the massage site, thereby altering the air pressure and size of the chamber 123. When the air pressure decreases, the chamber 123 shrinks under action of atmospheric pressure, and the opening 124 of the chamber 123 made of an elastic or flexible material such as silicone contracts to a certain extent in a direction perpendicular to a line connecting the two slots 125. When the air pressure returns to normal, the chamber 123 and the opening 124 resume their original shapes, thereby generating a hand-kneading massage effect. When the control circuit board 31 controls the air pump 32 to operate periodically, a continuous hand-kneading massage effect can be produced. Magnitude of a change in the chamber 123 is determined by magnitude of a change in the air pressure during the operation of the chamber 123. Since the massage is achieved by changing the air pressure of the chamber formed by the elastic rubber sleeve and possibly by deforming the shape of the opening 124 through the change in the air pressure, the massage is gentler. Continuous adjustment of massage intensity can be achieved by controlling the pressure of the chamber, thereby improving a use experience of a user.

In this embodiment, a thickness of the chamber sidewall 121 gradually increases from the inside to the outside. This can reduce a space of the chamber 123, making it easier for the chamber to change in size and for the opening 124 to deform when the air pump operates and when the air pressure is reduced more easily, thus better realizing a hand-kneading massage process. The chamber 123 increases from the inside to the outside in a length direction. A control air valve 36 is disposed between the air pump 32 and the chamber 123. During operation, controlling the chamber 123 by the control air valve 36 can achieve adjustment of air pressure magnitude and air pressure duration of the chamber 123. The shifting tongue 122 is not connected to the sidewall of the chamber. It is an elastic shifting piece made of the same material as the rubber sleeve 12, which is elastic or flexible, such as a silicone material. The shifting tongue 122 and the rubber sleeve 12 are integrally formed. The through hole 126 is located at a bottom of the chamber 123.

As a preferred implementation of this embodiment, the rubber sleeve further includes a shifting tongue 122, and the shifting tongue 122 is disposed within the chamber 123 and moves under the control of the control assembly. The shifting tongue 122 is made of the same material as the rubber sleeve, and preferably has an integrated structure with the rubber sleeve, which can enhance connection strength of the shifting tongue 122 and extend its service life.

On the basis of the above embodiment, the present invention further provides another embodiment. The first massage mechanism further includes a first vibration motor 331 and a fixing seat 332 for fixing the first vibration motor 331. The fixing seat 332 is provided with a mounting cavity (not shown in the drawings) and a mounting slot 3321 communicating with the mounting cavity. A circuit connecting the first vibration motor 331 and the control circuit board 31 passes through the mounting slot 3321. Under the control of the control circuit board 31, the first vibration motor 331 drives the shifting tongue 122 to perform vibration massage. During mounting, the first massage mechanism 33 is typically mounted in a cavity (not shown in the drawings) on the shifting tongue 122. Preferably, the cavity is slightly larger than the first massage mechanism 33, i.e., there is no interference fit. During operation, the first vibration motor 331 can be controlled by the control circuit board 31 to cause the shifting tongue 122 to generate vibration massage. As needed, the first vibration motor 331 and the air pump 32 can be controlled independently or in linkage. In linkage control, multiple massage effects, i.e., the shifting tongue's swing massage, hand-kneading massage, and vibration massage, can be superimposed, thereby better improving the massage effect.

As needed, the first massage mechanism further includes a reduction motor 34. An output shaft of the reduction motor 34 is connected to the fixing seat 332. Through the control of the control circuit board 31, the reduction motor 34 drives an operating first vibration motor 33 to make the shifting tongue 122 perform swing massage. When the first vibration motor 331 is in operation, both swing massage and vibration massage of the shifting tongue 122 can be achieved. The reduction motor 34 includes a motor 341, a reduction gear set (not shown in the drawings) drivingly connected to the motor 341, and an output shaft 342 connected to the reduction gear set. The output shaft 342 includes an output end connected to the fixing seat 332 and an input end connected to the reduction motor. An included angle a is formed between the input end and the output end. Through this included angle, when the output shaft 342 rotates, the first vibration motor 331 can be driven to rotate, causing the shifting tongue 122 to produce a swing massage effect. The included angle a between the input end and the output end is 120-175 degrees. To control swing amplitude, the included angle a is preferably 165-173 degrees.

As a preferred implementation of this embodiment, based on the above embodiment, the massage appliance further includes a second massage mechanism 2. The second massage mechanism 2 is disposed at the other end away from the first massage mechanism, and the second massage mechanism 2 includes a massage body 21 and a second vibration motor 22 disposed on the massage body. The second vibration motor 22 is connected to the control circuit board 31. During operation, under control, the second vibration motor 22 causes the massage body 21 to generate vibration massage. The vibration massage, swing massage, and hand-kneading massage of the second massage mechanism 2 and the first massage mechanism can be controlled independently or in linkage. How to control these can be set according to actual needs. The housing 1 is provided with a fixing portion for mounting the massage body 21. The fixing portion includes a protrusion along a length direction, and fixing slots 101 are annularly distributed on a surface of the protrusion.

An end of the massage body is provided with a massage ball. A diameter of the massage ball is larger than a minimum diameter of the massage body 21 but smaller than a maximum diameter of the massage body 21. A diameter of the massage body 21 gradually decreases from the housing to the massage ball. With this structure, when the second vibration motor 22 vibrates with a small amplitude, the massage ball can still generate a vibration swing, thereby reducing noise during massage by controlling a vibration amplitude of the second vibration motor 22. The massage ball can increase a contact area during massage, avoiding poor user experience caused by a small contact area. Meanwhile, this design can better adapt to regional massage. When the massage body 21 has certain elasticity, this can allow the massage ball to provide gentler vibration massage, thereby improving a massage use experience.

The above embodiments are only used to illustrate the technical solutions of the present invention, but not to limit them; although the present invention has been described in detail with reference to the foregoing embodiments, those of ordinary skill in the art should understand that: they can still modify the technical solutions recorded in the foregoing embodiments, or equivalently replace and combine some structures (technical features) in one or more embodiments. However, these modifications, replacements, or combinations do not cause the essence of the corresponding technical solutions to deviate from the spirit and scope of the technical solutions of the embodiments of the present invention, unless the embodiments explicitly exclude the possibility of replacing or combining structures (technical features) in different embodiments, or such replacement or combination contradicts the overall concept of the present invention.

What is claimed is:

1. A massage appliance, comprising a housing, a control assembly, and a first massage mechanism, wherein the housing is sleeved with a rubber sleeve, wherein the first massage mechanism comprises a chamber disposed within the rubber sleeve, and the chamber is provided with an opening; the control assembly comprises a control circuit board and an air pump connected to the control circuit board, an air inlet of the air pump is in communication with the chamber, and under control of the control circuit board, the air pump causes a change in air pressure of the chamber cooperating with a massage site, thereby altering the air pressure and a size of the chamber.

2. The massage appliance according to claim 1, wherein an end face of the opening is arc-shaped, and the opening is provided with two slots on the same straight line.

3. The massage appliance according to claim 1, wherein the chamber increases from the inside to the outside in a length direction, and a thickness of a side wall of the chamber gradually increases from the inside to the outside.

4. The massage appliance according to claim 2, wherein the chamber is provided with a through hole, the through hole is located at a bottom of the chamber, and the through hole communicates the air inlet of the pump with the chamber through a control air valve.

5. The massage appliance according to claim 1, wherein the rubber sleeve further comprises a shifting tongue disposed in the chamber and moved under control of the control assembly.

6. The massage appliance according to claim 1, wherein the first massage mechanism further comprises a first vibration motor and a fixing seat for fixing the first vibration motor, the fixing seat is provided with a mounting cavity and a mounting slot communicating with the mounting cavity, a circuit connecting the first vibration motor and the control circuit board passes through the mounting slot, and under the control of the control circuit board, the first vibration motor drives the shifting tongue to perform vibration massage.

7. The massage appliance according to claim 6, wherein the first massage mechanism further comprises a reduction motor, an output shaft of the reduction motor is connected to the fixing seat, and through the control of the control circuit board, the reduction motor drives an operating first vibration motor to make the shifting tongue perform swing massage and vibration massage, or the reduction motor causes the shifting tongue to perform swing massage through the first vibration motor.

8. The massage appliance according to claim 7, wherein the output shaft comprises an output end connected to the fixing seat and an input end connected to the reduction motor, an included angle is formed between the input end and the output end, and the included angle is 165-173 degrees.

9. The massage appliance according to claim 5, wherein the shifting tongue is an elastic or flexible shifting piece.

10. The massage appliance according to claim 5, wherein the massage appliance further comprises a second massage mechanism, the second massage mechanism comprises a massage body and a second vibration motor disposed on the massage body, and under the control of the control circuit board, the second vibration motor causes the massage body to generate vibration massage.

11. The massage appliance according to claim 10, wherein the housing is provided with a fixing portion for mounting the massage body, the fixing portion comprises a protrusion along a length direction, and fixing slots are annularly distributed on a surface of the protrusion.

12. The massage appliance according to claim 1, wherein a control valve controlled by the control circuit board is disposed between the air pump and the chamber.

13. The massage appliance according to claim 1, wherein an end of the massage body is provided with a massage ball, a diameter of the massage body gradually decreases from the housing to the massage ball, and a diameter of the massage ball is larger than a minimum diameter of the massage body and smaller than a maximum diameter of the massage body.
